(19) United States
(12) Patent Application Publication
(10) Pub. No.: US 2024/0295243 A1
(43) Pub. Date: Sep. 5, 2024

(54) Clutch Piston

(71) Applicant: Kabushiki Kaisha F.C.C., Hamamatsu-shi (JP)

(72) Inventors: Nobuhiro HIMENO, Hamamatsu-shi (JP); Yoshikatsu SAKAGUCHI, Hamamatsu-shi (JP); Makoto AMANO, Hamamatsu-shi (JP)

(21) Appl. No.: 18/661,923

(22) Filed: May 13, 2024

Related U.S. Application Data
(63) Continuation of application No. PCT/JP2022/040567, filed on Oct. 28, 2022.

(30) Foreign Application Priority Data
Dec. 8, 2021 (JP) 2021-199544

(51) Int. Cl. F16D 25/12; F16D 25/0638

(52) U.S. Cl. CPC F16D 25/12; F16D 25/0638

(57) ABSTRACT

A clutch piston 1 is attached to a clutch with clutch plates 5 and a return spring 6. The clutch piston 1 has an operation portion 2 that transmits motive power by causing the clutch plates 5 to be in pressure contact with each other. Also, it breaks transmission of a driving force by releasing a force generated by the clutch plates 5 in pressure contact with each other. A holding portion 3 holds one end portion 6a of the return spring 6. A recessed portion 4 is formed in a predetermined part of the holding portion 3. It has inclined wall surfaces 4c, connecting edge surfaces 4a and a bottom surface 4b.

### CROSS-REFERENCE TO RELATED APPLICATIONS

This application is a continuation of International Application No. PCT/JP2022/040567, filed Oct. 28, 2022, which claims priority to Japanese Application No. 2021-199544, Dec. 8, 2021. The disclosures of the above applications are incorporating herein by reference.

### FIELD

The present disclosure relates to a clutch piston attached to a clutch that includes clutch plates and return springs. It is capable of transmitting the driving force of a vehicle or breaking the transmission of the driving force by displacement in the axial direction.

### BACKGROUND

A clutch included in a vehicle, such as an automobile, typically includes a plurality of clutch plates (frictional engagement elements) that are stacked and disposed with respect to one another. A clutch piston is capable of displacing in the axial direction by oil pressure. Return springs are each disposed such that one end portion of the plates is in contact with a clutch spring. The clutch piston is displaced against the urging force of the return springs to cause the clutch plates to be in pressure contact with each other. Thus, this enables the driving force of the vehicle to be transmitted to the wheel side (see, for example, Japanese Unexamined Patent Application Publication No. 2017-110738).

### SUMMARY

However, the related art described above has the following problems.

Clutch pistons have been recently required to be used under a high-pressure condition, for example, to improve responsivity. Also, it is required to reduce the thicknesses of the components, for example, for size reduction and weight reduction. It can be considered that such requirements are addressed by significantly changing the materials or the shapes of clutch pistons. However, in this case, manufacturing costs may be increased.

In addition, in such an existing clutch piston, stress is concentrated on a predetermined part, specifically a corner portion in the vicinity of the position where a return spring is held, when causing clutch plates to be in pressure contact with each other. Thus, this causes breakage or deformation in some cases. Accordingly, in addition to reducing manufacturing costs, it is required that the stress generated when causing the clutch plates to be in pressure contact with each other be dispersed to avoid stress concentration.

The present disclosure is made in view of such circumstances. It is an object of the present disclosure to provide a clutch piston capable of avoiding stress concentration by dispersing the stress generated when causing clutch plates to be in pressure contact with each other while inhibiting an increase in manufacturing costs.

According to the disclosure, a clutch piston is attached to a clutch that includes clutch plates and a return spring. The clutch piston is capable of transmitting a driving force of a vehicle or breaking the transmission of the driving force by displacing in an axial direction. The clutch piston includes an operation portion, a holding portion and a recessed portion. The operation portion transmits motive power by causing the clutch plates to be in pressure contact with each other and breaks transmission of a driving force by releasing a force generated by the clutch plates in pressure contact with each other. The holding portion holds one end portion of the return spring. The recessed portion is formed in a predetermined part of the holding portion and has inclined wall surfaces, and connecting edge surfaces and a bottom surface.

According to the disclosure, the recessed portion has boundaries, having an r shape, between the edge surfaces and the wall surfaces, and/or boundaries, having an r shape, between the bottom surface and the wall surfaces.

According to the disclosure described, the holding portion has bearing surfaces in contact with the one end portion of the return spring. The recessed portion is formed at a position inside the bearing surfaces.

According to the disclosure, a plurality of the holding portions are formed at regular intervals throughout in a circumferential direction. The holding portions adjacent to each other are connected by a connection region. The recessed portion continuously forms an annular shape throughout along the holding portions and connection regions.

According to the disclosure, a width of each of the connection regions is set to be smaller than a width of each of the holding portions. The connection regions and the holding portions continuously form an annular shape so as to form a wave shape in plan view. The recessed portion is formed along the wave shape.

According to the disclosure, the holding portion has a bearing surface in contact with the one end portion of the return spring. The recessed portion is formed at a position on a rear surface side of the bearing surface.

According to the disclosure, the clutch piston includes the operation portion, holding portion and recessed portion. The operation portion transmits motive power by causing the clutch plates to be in pressure contact with each other and breaks transmission of a driving force by releasing a force generated by the clutch plates in pressure contact with each other. The holding portion holds the one end portion of the return spring. The recessed portion is formed in the predetermined part of the holding portion. It has the inclined wall surfaces connecting the edge surfaces and the bottom surface. Thus, the recessed portion enables a reduction in the thickness of the holding portion. Also, it enables concentration of stress on the holding portion to be avoided with the simple configuration. Accordingly, it is possible to avoid stress concentration by dispersing the stress generated when causing the clutch plates to be in pressure contact with each other while inhibiting an increase in manufacturing costs.

According to the disclosure, the recessed portion has the boundaries, with an r shape, between the edge surfaces and the wall surfaces, and/or the boundaries, have an r shape, between the bottom surface and the wall surfaces. Thus, it is possible to avoid stress concentration by more securely dispersing the stress generated when causing the clutch plates to be in pressure contact with each other.

According to the disclosure, the holding portion has the bearing surfaces in contact with the one end portion of the return spring. The recessed portion is formed at the position inside the bearing surfaces. Thus, the recessed portion can be formed by effectively using the space located inside the bearing surfaces. Accordingly, it is possible to avoid stress concentration by more securely dispersing the stress generated when causing the clutch plates to be in pressure contact with each other.

According to the disclosure, a plurality of the holding portions are formed at regular intervals throughout in the circumferential direction. The holding portions adjacent to each other are connected by the connection region. The recessed portion continuously forms an annular shape throughout along the holding portions and the connection regions. Thus, it is possible to form the recessed portion in the circumferential direction throughout along the holding portions and the connection regions. Accordingly, it is possible to avoid stress concentration by even more securely dispersing the stress generated when causing the clutch plates to be in pressure contact with each other.

According to the disclosure, the width of each of the connection regions is set to be smaller than the width of each of the holding portions. The connection regions and the holding portions continuously form an annular shape so as to form a wave shape in plan view. The recessed portion is formed along the wave shape. Thus, it is possible to prevent the recessed portion from being increased in size more than necessary and from being excessively reduced in strength. In addition, it is possible to avoid stress concentration in the connection regions having a small width.

According to the disclosure, the holding portion has the bearing surface in contact with the one end portion of the return spring. The recessed portion is formed at the position on the rear surface side of the bearing surface. Thus, the recessed portion can be formed by effectively using the space on the rear surface side of the clutch piston. Accordingly, it is possible to avoid stress concentration by more securely dispersing the stress generated when causing the clutch plates to be in pressure contact with each other.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic sectional view of a clutch with a clutch piston according to the present disclosure.

FIG. 2 is a perspective view of a front surface side exterior of the clutch piston.

FIG. 3 is a perspective view of a rear surface side exterior of the clutch piston.

FIG. 4 is a plan view of the clutch piston.

FIG. 5 is a sectional view taken along line V-V in FIG. 4.

FIG. 6 is a schematic view of a recessed portion of the clutch piston.

FIG. 7 is a schematic view of a recessed portion in another embodiment.

FIG. 8 is a schematic view of a recessed portion in still another embodiment.

FIG. 9 is a perspective view of a front surface side exterior of a clutch piston according to a second embodiment of the present disclosure.

FIG. 10 is a perspective view of a rear surface side exterior of the clutch piston.

FIG. 11 is a plan view and a rear plan view of the clutch piston.

FIG. 12 is a sectional view taken along line XII-XII in FIG. 11.

### DETAILED DESCRIPTION

Embodiments of the present disclosure will be specifically described below with reference to the drawings.

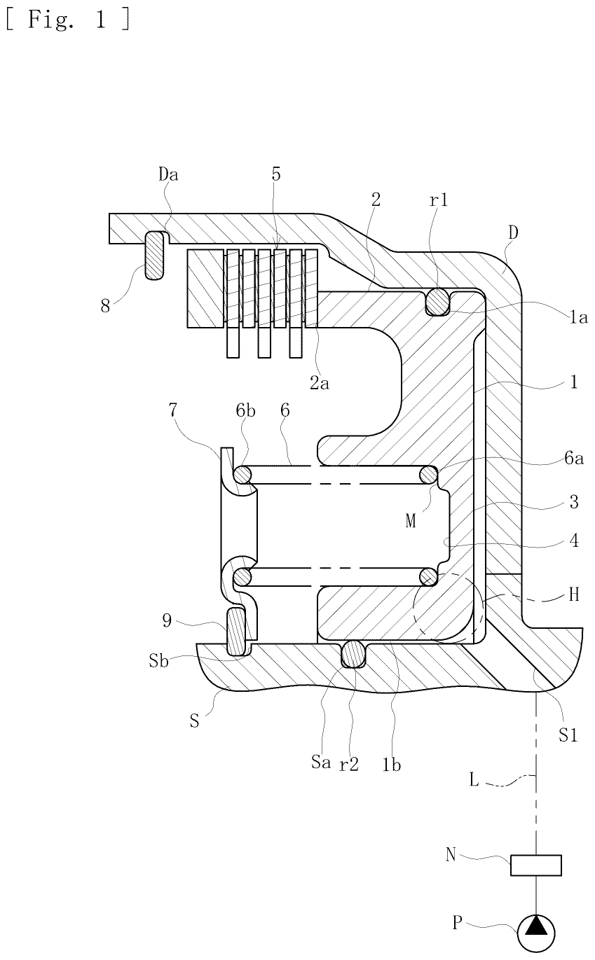

A clutch piston 1 according to a first embodiment of the present disclosure is applied to a clutch piston mechanism attached to an automatic transmission of an automobile, for example. As illustrated in FIG. 1, the clutch piston 1 is attached to a clutch that includes clutch plates 5 and return springs 6. It is capable of transmitting the driving force of a vehicle or breaking the transmission of the driving force by displacing in the axial direction (left-right direction in FIG. 1).

As illustrated in FIG. 1, the applied clutch is formed by the clutch piston 1, a plurality of the clutch plates 5, which are disposed in a clutch drum D, the return springs 6, which urge the clutch piston 1 toward the initial position (right side in FIG. 1), and a clutch shaft S, which has an oil flow hole S1. Seal members r1 and r2 are respectively fitted into a groove shape 1a, formed in the clutch piston 1, and a groove shape Sa, formed in the clutch shaft S.

The clutch drum D has a groove shape Da in an inner peripheral surface. A circlip 8 is attached to the groove shape Da. The clutch shaft S has a groove shape Sb in an outer peripheral surface. A circlip 9 is attached to the groove shape Sb. In addition, a spring holder 7, for receiving the other end portion 6b of each of the return springs 6, is attached to the circlip 9.

The plurality of clutch plates 5 are stacked and disposed on the operation portion of the clutch piston. The plurality of clutch plates 5 is capable of transmitting the driving force of a vehicle by being pressed and caused to be in pressure contact with each other by an operation portion 2 of the clutch piston 1. Also, the plurality of plates is capable of breaking the transmission of the driving force of the vehicle by separation of the operation portion 2 of the clutch piston 1 from the clutch plates 5. This releases the force generated by the clutch plates 5 in pressure contact with each other. Then, when the plurality of clutch plates 5 is pressed by the clutch piston 1, the clutch plates 5 move to the circlip 8 and can receive a pressing force.

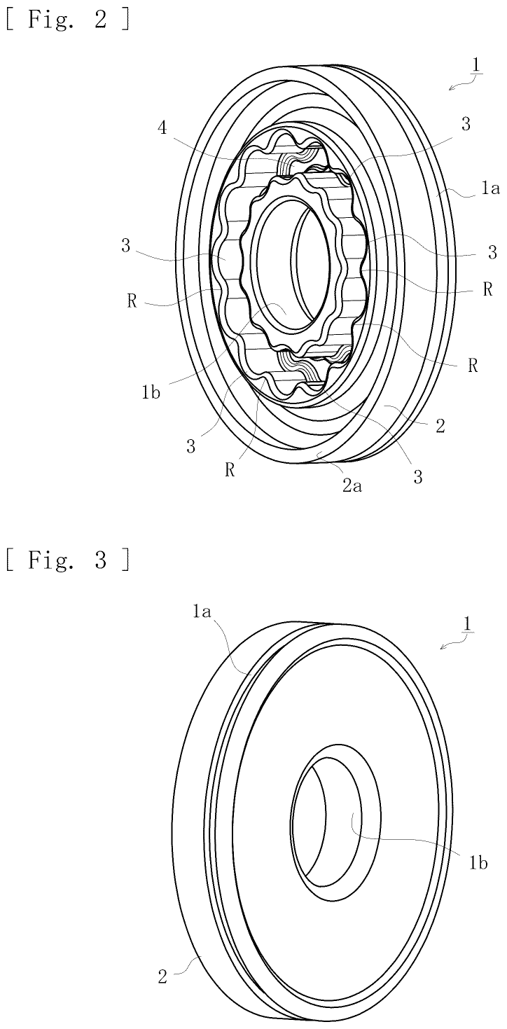

As illustrated in FIGS. 2 to 5, the clutch piston 1 is made of a cylindrical metal material. The seal member r1 (for example, an O ring) is fitted into the groove shape 1a formed in a side surface of the clutch piston 1. In addition, a central hole 1b, into which the clutch shaft S is inserted, is formed at the central position of the clutch piston 1. Thus, the clutch piston 1 is capable of being displaced in the axial direction along the clutch shaft S where an inner peripheral surface is sealed by the seal member r2 while an outer peripheral surface is sealed by the seal member r1.

In addition, the oil flow hole S1, formed in the clutch shaft S, is connected to an oil flow passage L extending from an oil pump P. Oil is supplied therethrough at any given time to the rear surface side of the clutch piston 1 in the clutch drum D. Furthermore, a controller N operates at any given time and is capable of controlling the oil supplied from the oil pump P to flow into the oil flow passage L.

The return spring 6 is formed by a coil spring with one end portion 6a and the other end portion 6b. The one end portion 6a is held by a holding portion 3 of the clutch piston 1. The other end portion 6b is held by the spring holder 7. Thus, when oil is guided in through the oil flow hole S1, by operation of the oil pump P, the clutch piston 1 is displaced to the left side in FIG. 1 against the urging force of the return springs 6 and presses the clutch plates 5. In addition, when the oil pump P stops to stop guiding oil in through the oil flow hole S1, the clutch piston 1 is displaced to the right side in FIG. 1 with the urging force of the return springs 6 and is separated from the clutch plates 5.

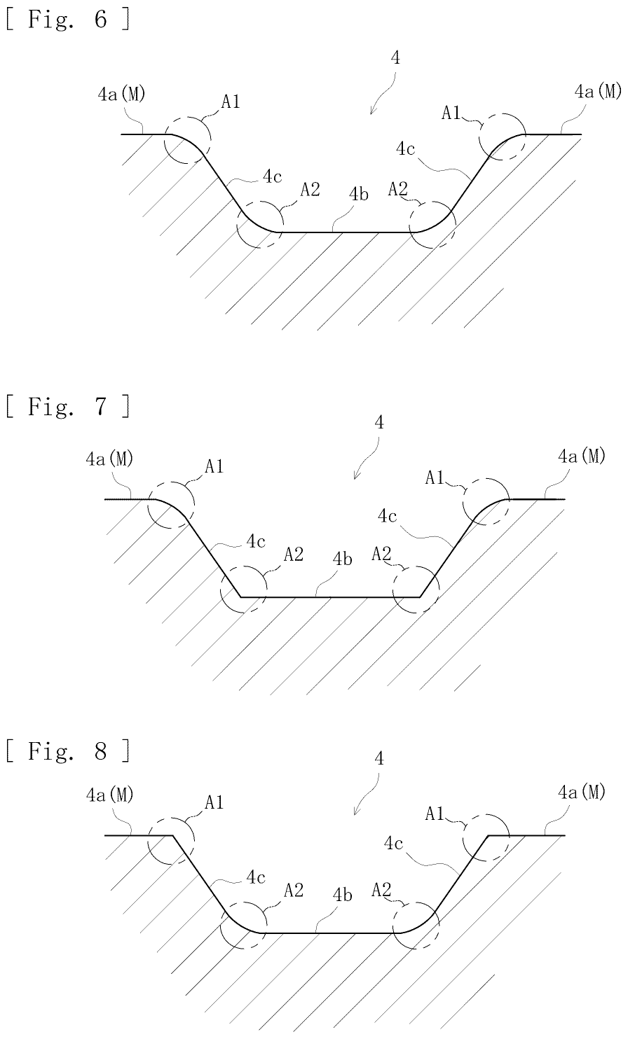

Here, the clutch piston 1 includes the operation portion 2, which transmits motive power by causing the clutch plates 5 to be in pressure contact with each other and breaks the transmission of the driving force by releasing the force generated by the clutch plates 5 in pressure contact with each other. The holding portion 3 holds the one end portion 6a of the return spring 6. A recessed portion 4 is formed in a predetermined part of the holding portion 3. The recessed portion 4 has inclined wall surfaces 4c (see FIG. 6), connecting edge surfaces 4a and a bottom surface 4b. As illustrated in FIGS. 6 to 8, the respective wall surfaces 4c are formed on the radially inside and outside in the clutch piston 1.

The operation portion 2 is formed at a peripheral portion of the clutch piston 1. In addition, the tip of the operation portion 2 has a press surface 2a capable of being in contact with the clutch plates 5 and pressing the clutch plates 5 as a result of displacement (displacement to the left side in FIG. 1) of the clutch piston 1. In the present embodiment, the operation portion 2 is formed all around the clutch piston 1. However, a plurality of operation portions 2 may be formed around the clutch piston 1 at regular intervals.

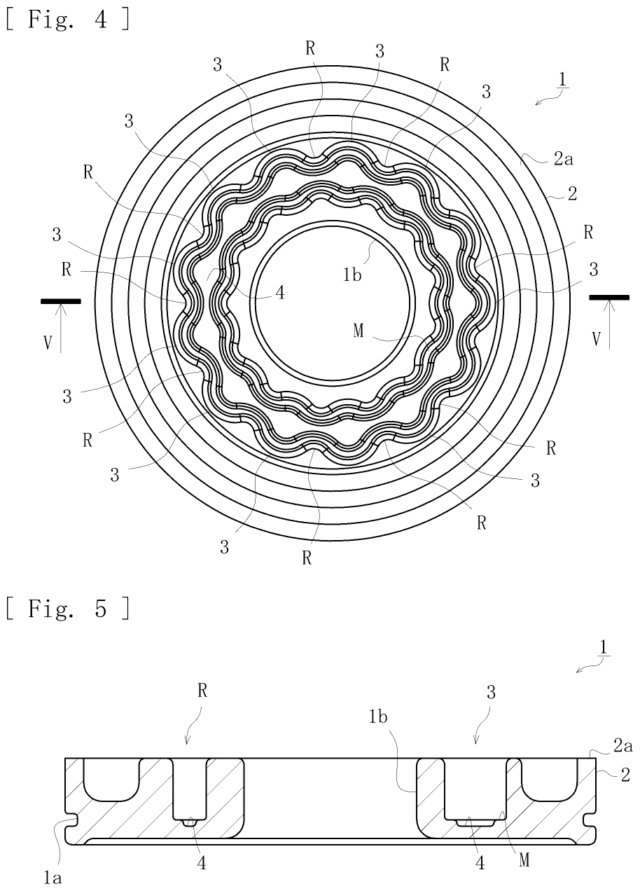

The holding portion 3 is formed at the central part of the clutch piston 1 and has bearing surfaces M (see FIG. 5), that are in contact with the one end portion 6a of the return spring 6. As illustrated in FIG. 4, a plurality of the holding portions 3 are formed at regular intervals throughout the clutch piston 1 in the circumferential direction of the clutch piston 1. Each one holds a corresponding one of the return springs 6. The bearing surfaces M is capable of being in contact with the one end portion 6a of the return spring 6. The bearing surfaces M are formed at respective edge portions of the bottom surface of the holding portion 3.

In addition, the holding portions 3, adjacent to each other, are connected by a connection region R. The holding portions 3 and the connection regions R are formed alternately throughout the clutch piston 1 in the circumferential direction. Furthermore, as illustrated in FIG. 4, the width of each of the connection regions R is set to be smaller than that of each of the holding portions 3, in plan view. The connection regions R and the holding portions 3 continuously form an annular shape so as to form a wave shape. A shape where wide portions and narrow portions continue alternately in plan view. The return springs 6 are not held in the connection regions R. Thus, the bearing surfaces M, in contact with the one end portion 6a, are not formed at respective edge portions of the bottom surface of each of the connection regions R.

In this manner, the width of each of the connection regions R is set to be smaller than that of each of the holding portions 3. The connection regions R and the holding portions 3 form an annular shape so as to form a wave shape. Thus, it is possible to form side walls of the holding portion 3 to follow a side surface of the one end portion 6a of the return spring 6. Thus, this stably holds the return spring 6.

The recessed portion 4 is formed by a part formed at a position inside the bearing surfaces M of the holding portions 3. In the present embodiment, as illustrated in FIG. 4, the recessed portion 4 continuously forms an annular shape throughout the clutch piston 1 along the holding portions 3 and the connection regions R. In addition, the recessed portion 4, according to the present embodiment, is formed along the wave shape formed by the connection regions R and the holding portions 3. The recessed portion 4 is wide in the holding portions 3 and is narrow in the connection regions R. It continuously forms an annular shape so as to form a wave shape in plan view.

The recessed portion 4 enables a reduction in the thickness of the holding portions 3 and enables stress to be inhibited from being concentrated on a loaded region (inner corner portion) represented by a reference sign H in FIG. 1 when the clutch piston 1 is displaced and presses the clutch plates 5. That is, when the holding portions 3 are uniform in thickness and the clutch piston 1 is displaced and presses the clutch plates 5, stress is concentrated on the loaded region H, thus causing deformation or breakage in some cases. On the other hand, the recessed portion 4 is formed to reduce the thickness of the holding portions 3, thus enabling dispersion of the stress generated in the loaded region H.

Furthermore, as illustrated in FIG. 6, the recessed portion 4, according to the present embodiment, has the inclined wall surfaces 4c that connect the edge surfaces 4a (that is, the bearing surfaces M) and the bottom surface 4b. Specifically, the wall surfaces 4c of the recessed portion 4 form inclined surfaces inclined at a predetermined angle relative to the direction perpendicular to the bottom surface 4b (up-down direction in FIG. 6). Thus, they have a shape that facilitates dispersion of stress. In addition, in the recessed portion 4, according to the present embodiment, boundaries A1 between the edge surfaces 4a and the wall surfaces 4c and boundaries A2. between the bottom surface 4b and the wall surfaces 4c, each have a predetermined curvature and have an overall r shape.

However, although the boundaries A1 and A2 each have an r shape, in the present embodiment, as illustrated in FIG. 7, the recessed portion 4 may have the boundaries A1, having an r shape, and the boundaries A2 not having such an r shape. Alternatively, as illustrated in FIG. 8, the recessed portion 4 may have the boundaries A2, having an r shape and the boundaries A1 not having such an r shape. In addition, the boundaries A1, having an r shape, and the boundaries A2, having an r shape, may continue to form the wall surfaces 4c.

According to the present embodiment, the clutch piston 1 includes the operation portion 2, which transmits motive power by causing the clutch plates 5 to be in pressure contact with each other and breaks the transmission of the driving force by releasing the force generated by the clutch plates 5 in pressure contact with each other. The holding portion 3 holds the one end portion 6a of the return spring 6. The recessed portion 4 is formed in a predetermined part of the holding portion 3. The recessed portion 4 has the inclined wall surfaces 4c, connecting the edge surfaces 4a, and the bottom surface 4b. Thus, the recessed portion 4 enables a reduction in the thickness of the holding portions 3. Also, it enables concentration of stress on the holding portions 3 to be avoided with the simple configuration. Accordingly, it is possible to avoid stress concentration by dispersing the stress generated when causing the clutch plates 5 to be in pressure contact with each other while inhibiting an increase in manufacturing costs.

In addition, the recessed portion 4 according to the present embodiment has the boundaries A1, having an r shape, between the edge surfaces 4a and the wall surfaces 4c and/or the boundaries A2, having an r shape, between the bottom surface 4b and the wall surfaces 4c. Thus, it is possible to avoid stress concentration by more securely dispersing the stress generated when causing the clutch plates 5 to be in pressure contact with each other. Furthermore, the holding portion 3, according to the present embodiment, has the bearing surfaces M in contact with the one end portion 6a of the return spring 6. The recessed portion 4 is formed at a position inside the bearing surfaces M. Thus, the recessed portion 4 can be formed by effectively using the space located inside the bearing surfaces M. Accordingly, it is possible to avoid stress concentration by more securely dispersing the stress generated when causing the clutch plates 5 to be in pressure contact with each other.

Furthermore, a plurality of the holding portions 3, according to the present embodiment, is formed at regular intervals throughout the clutch piston in the circumferential direction. The holding portions 3 adjacent to each other are connected by the connection region R. The recessed portion 4 continuously forms an annular shape throughout the clutch piston along the holding portions 3 and the connection regions R. Thus, it is possible to form the recessed portion 4 in the circumferential direction throughout the clutch piston 1 along the holding portions 3 and the connection regions R. Accordingly, it is possible to avoid stress concentration by even more securely dispersing the stress generated when causing the clutch plates 5 to be in pressure contact with each other.

In addition, the width of each of the connection regions R, according to the present embodiment, is set to be smaller than that of each of the holding portions 3. The connection regions R and the holding portions 3 continuously form an annular shape so as to form a wave shape in plan view. The recessed portion 4 is formed along the wave shape. Thus, it is possible to prevent the recessed portion 4 from being increased in size more than necessary and from being excessively reduced in strength. In addition, it is possible to avoid stress concentration in the connection regions R having a small width.

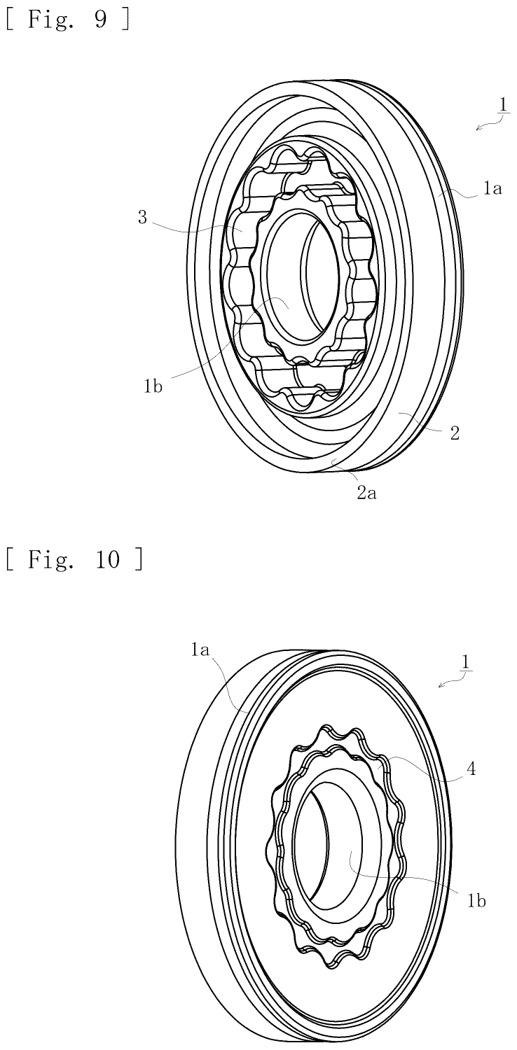

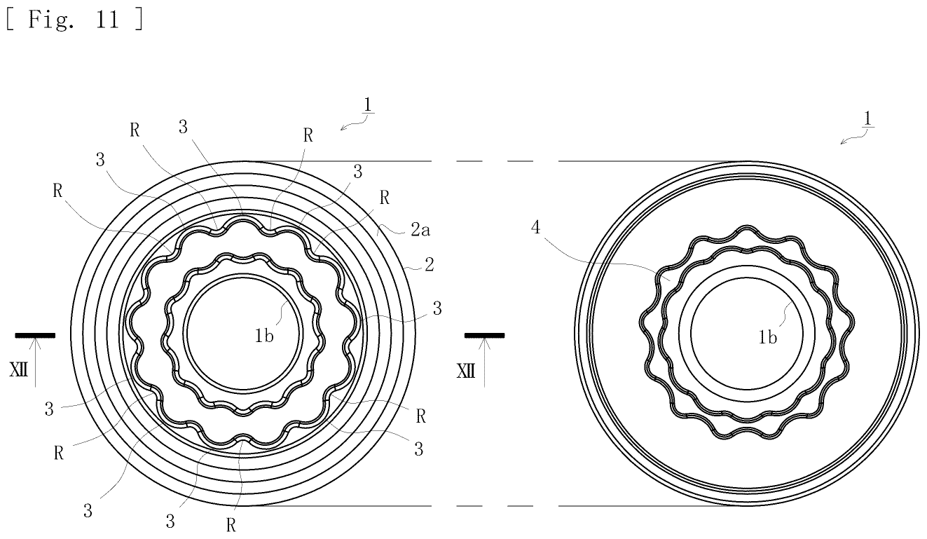

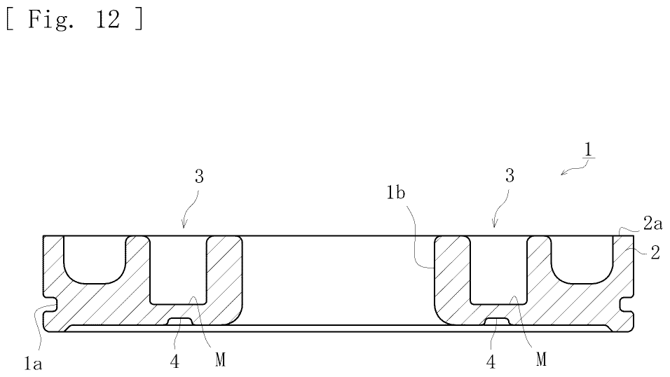

The present embodiment has been described above, but the present disclosure is not limited. For example, as illustrated in FIGS. 9 to 12, the recessed portion 4 may be formed at a position on the rear surface side of the bearing surface M formed in the holding portion 3. In this case, similarly to the above embodiment, as illustrated in FIGS. 9 to 11, the front surface side of the clutch piston 1 has the holding portions 3 and the connection regions R. The bottom surface of the holding portion 3 forms the bearing surface M (see FIG. 12) in contact with the one end portion 6a of the return spring 6. The recessed portion 4 is formed at a position on the rear surface side of the bearing surface M, that is, the position that is on the rear surface side of the clutch piston 1 and that corresponds to the bearing surface M.

In this manner, the holding portion 3 has the bearing surface M in contact with the one end portion 6a of the return spring 6. The recessed portion 4 is formed at a position on the rear surface side of the bearing surface M. Thus, the recessed portion 4 can be formed by effectively using the space on the rear surface side of the clutch piston 1. Accordingly, it is possible to avoid stress concentration by more securely dispersing the stress generated when causing the clutch plates 5 to be in pressure contact with each other.

For example, a plurality of the holding portions 3 may be formed at regular intervals in the circumferential direction without being connected by the connection regions R. The recessed portion 4 may be formed so as to simply extend annularly without extending so as to form a wave shape. In addition, the present disclosure is applied to an automobile in the present embodiment but may be applied to clutches in other vehicles in addition to such automobiles.

The present disclosure is also applicable to, for example, clutch pistons with different external shapes or with other added functions as long as the clutch pistons each include an operation portion that transmits motive power by causing clutch plates to be in pressure contact with each other and breaks the transmission of the driving force by releasing the force generated by the clutch plates in pressure contact with each other. A holding portion holds one end portion of a return spring. A recessed portion, formed in a predetermined part of the holding portion, has inclined wall surfaces, connecting edge surfaces and a bottom surface.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A clutch piston attached to a clutch including clutch plates and a return spring, the clutch piston, capable of transmitting a driving force of a vehicle or breaking a transmission of the driving force, displacing in an axial direction, the clutch piston comprising:
an operation portion that transmits motive power by causing the clutch plates to be in pressure contact with each other and breaks transmission of a driving force by releasing a force generated by the clutch plates in pressure contact with each other;
a holding portion that holds one end portion of the return spring; and
a recessed portion formed in a predetermined part of the holding portion and has inclined wall surfaces, connecting edge surfaces and a bottom surface.

2. The clutch piston according to claim 1, wherein the recessed portion has boundaries, having an r shape, between the edge surfaces and the wall surfaces, and/or boundaries, having an r shape, between the bottom surface and the wall surfaces.

3. The clutch piston according to claim 1, wherein the holding portion has bearing surfaces in contact with the one end portion of the return spring, and the recessed portion is formed at a position inside the bearing surfaces.

4. The clutch piston according to claim 1, wherein a plurality of the holding portions are formed at regular intervals throughout the clutch piston in a circumferential direction, the holding portions adjacent to each other are connected by a connection region; and the recessed portion continuously forms an annular shape throughout the clutch piston along the holding portions and connection regions.

5. The clutch piston according to claim 4, wherein a width of each of the connection regions is set to be smaller than a width of each of the holding portions, the connection regions and the holding portions continuously form an annular shape so as to form a wave shape in plan view; and the recessed portion is formed along the wave shape.

6. The clutch piston according to claim 1, wherein the holding portion has a bearing surface in contact with the one end portion of the return spring; and the recessed portion is formed at a position on a rear surface side of the bearing surface.
